(19) United States
(12) Patent Application Publication
(10) Pub. No.: US 2024/0298274 A1
(43) Pub. Date: Sep. 5, 2024

(54) LINEAR COMPUTATION OF RADIO FREQUENCY EXPOSURE FOR COHERENT TRANSMISSIONS

(71) Applicant: QUALCOMM Incorporated, San Diego, CA (US)

(72) Inventors: Jagadish NADAKUDUTI, Bermuda Dunes, CA (US); Lin LU, San Diego, CA (US)

(21) Appl. No.: 18/593,190

(22) Filed: Mar. 1, 2024

Related U.S. Application Data
(60) Provisional application No. 63/449,896, filed on Mar. 3, 2023.

(51) Int. Cl. H04W 52/36; H04B 7/0413; H04W 52/28

(52) U.S. Cl. CPC H04W 52/367; H04B 7/0413; H04W 52/28

(57) ABSTRACT

Certain aspects of the present disclosure provide techniques and apparatus for radio frequency (RF) exposure compliance for coherent transmissions. An example method of wireless communication includes obtaining a first transmit power limit associated with a coherent transmission mode, wherein the first transmit power limit is adjusted by a scaling factor associated with the coherent transmission mode. The method also includes transmitting first signals via a plurality of antennas in the coherent transmission mode at a first transmit power determined based at least in part on the first transmit power limit.

### CROSS-REFERENCE TO RELATED APPLICATION

This application claims the benefit of U.S. Provisional Patent Application Ser. No. 63/449,896, filed Mar. 3, 2023, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

Certain aspects of the subject matter described in this disclosure can be implemented in a method of wireless communication by a wireless device. The method generally includes obtaining a first transmit power limit associated with a coherent transmission mode. The first transmit power limit is adjusted by a scaling factor associated with the coherent transmission mode. The method also includes transmitting first signals via a plurality of antennas in the coherent transmission mode at a first transmit power determined based at least in part on the first transmit power limit.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to obtain a first transmit power limit associated with a coherent transmission mode, wherein the first transmit power limit is adjusted by a scaling factor associated with the coherent transmission mode, and transmit first signals via a plurality of antennas in the coherent transmission mode at a first transmit power determined based at least in part on the first transmit power limit.

Certain aspects of the subject matter described in this disclosure can be implemented in an apparatus for wireless communication. The apparatus generally includes means for obtaining a first transmit power limit associated with a coherent transmission mode. The first transmit power limit is adjusted by a scaling factor associated with the coherent transmission mode. The apparatus also includes means for transmitting first signals via a plurality of antennas in the coherent transmission mode at a first transmit power determined based at least in part on the first transmit power limit.

Certain aspects of the subject matter described in this disclosure can be implemented in a computer-readable medium. The computer-readable medium has instructions stored thereon, that when executed by an apparatus, cause the apparatus to perform an operation. The operation generally includes obtaining a first transmit power limit associated with a coherent transmission mode. The first transmit power limit is adjusted by a scaling factor associated with the coherent transmission mode. The operation also includes transmitting first signals via a plurality of antennas in the coherent transmission mode at a first transmit power determined based at least in part on the first transmit power limit.

Certain aspects of the subject matter described in this disclosure can be implemented in a method of determining a transmit power limit for radio frequency (RF) exposure compliance. The method generally includes obtaining a first RF exposure level associated with when only a first antenna is used to transmit a signal. The method also includes obtaining a second RF exposure level associated with when only a second antenna is used to transmit the signal. The method further includes obtaining a third RF exposure level associated with when a plurality of antennas is used to transmit the signal in a coherent transmission mode. The plurality of antennas includes the first antenna and the second antenna. The method further includes determining a first transmit power limit associated with the coherent transmission mode based at least in part on the first RF exposure level, the second RF exposure level, and the third RF exposure level. The method further includes storing the first transmit power limit in one or more wireless communication devices.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to obtain a first RF exposure level associated with when only a first antenna is used to transmit a signal; obtain a second RF exposure level associated with when only a second antenna is used to transmit the signal; obtain a third RF exposure level associated with when a plurality of antennas is used to transmit the signal in a coherent transmission mode, where the plurality of antennas includes the first antenna and the second antenna; determine a first transmit power limit associated with the coherent transmission mode based at least in part on the first RF exposure level, the second RF exposure level, and the third RF exposure level; and store the first transmit power limit in one or more wireless communication devices.

Certain aspects of the subject matter described in this disclosure can be implemented in an apparatus for wireless communication. The apparatus generally includes means for obtaining a first RF exposure level associated with when only a first antenna is used to transmit a signal. The apparatus also includes means for obtaining a second RF exposure level associated with when only a second antenna is used to transmit the signal. The apparatus further includes means for obtaining a third RF exposure level associated with when a plurality of antennas is used to transmit the signal in a coherent transmission mode. The plurality of antennas includes the first antenna and the second antenna. The apparatus further includes means for determining a first transmit power limit associated with the coherent transmission mode based at least in part on the first RF exposure level, the second RF exposure level, and the third RF exposure level. The apparatus further includes means for storing the first transmit power limit in one or more wireless communication devices.

Certain aspects of the subject matter described in this disclosure can be implemented in a computer-readable medium. The computer-readable medium has instructions stored thereon, that when executed by an apparatus, cause the apparatus to perform an operation. The operation generally includes obtaining a first RF exposure level associated with when only a first antenna is used to transmit a signal. The operation also includes obtaining a second RF exposure level associated with when only a second antenna is used to transmit the signal. The operation further includes obtaining a third RF exposure level associated with when a plurality of antennas is used to transmit the signal in a coherent transmission mode. The plurality of antennas includes the first antenna and the second antenna. The operation further includes determining a first transmit power limit associated with the coherent transmission mode based at least in part on the first RF exposure level, the second RF exposure level, and the third RF exposure level. The operation further includes storing the first transmit power limit in one or more wireless communication devices.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network exhibiting radio frequency (RF) exposure to a human, in accordance with certain aspects of the present disclosure.

FIG. 2 is a block diagram conceptually illustrating a design of an example a wireless communication device communicating with another device, in accordance with certain aspects of the present disclosure.

FIG. 3 is a graph illustrating examples of transmit powers over time in compliance with a RF exposure limit, in accordance with certain aspects of the present disclosure.

FIG. 4 is a diagram illustrating an example system for measuring RF exposure levels or distributions associated with a wireless communication device, in accordance with certain aspects of the present disclosure.

FIG. 5 is a flow diagram illustrating example operations for ensuring compliance with a time-averaged RF exposure regulatory limit, in accordance with certain aspects of the present disclosure.

FIG. 6 is a flow diagram illustrating example operations for wireless communication by a wireless device, in accordance with certain aspects of the present disclosure.

FIG. 7 is a flow diagram illustrating example operations for determining a transmit power limit, in accordance with certain aspects of the present disclosure.

FIG. 8 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for complying with radio frequency (RF) exposure limits for coherent transmissions.

In certain cases, a wireless communication device may perform a time-averaged evaluation to ensure that transmissions comply with an RF exposure limit. For non-coherent transmissions (e.g., signals that are not synchronized in frequency, phase, transmit power, etc.), the wireless device may evaluate the time-averaged RF exposure using a linear computation, such as a summation of past transmit powers over time. For coherent transmissions (e.g., signals that are synchronized in frequency, phase, transmit power, etc.), the time-averaged evaluation may apply a non-linear operation to account for the RF emissions associated with coherent signals. As an example, a coherent transmission may involve a multiple-input, multiple-output (MIMO) transmission. The non-linear operation may be computationally intensive for certain devices, such as a portable computational device including a smartphone or tablet. As the time-averaging evaluation may be repeatedly updated on a rolling basis (e.g., every 500 milliseconds), a wireless device may not be capable of completing the non-linear operation in every iteration associated with the time-averaging evaluation. In some cases, the non-linear operation may use additional power consumption and/or excessive computational resources that could be allocated to other signal processing operations, such as digital signal processing, automatic gain control, precoding, and forward error correction, as illustrative, non-limiting examples.

Aspects of the present disclosure provide apparatus and methods for RF exposure compliance for coherent transmissions using a computation with reduced complexity (e.g., a linear computation as opposed to a non-linear computation involving square roots). Transmit power limits (e.g., Pₗᵢₘᵢₜ) for separate antennas may be scaled to account for the non-linear effects of a coherent transmission, as further described herein. The wireless device may apply a linear operation, using the scaled transmit power limits, in determining the time-averaged exposure for coherent transmissions. Such a time-averaging evaluation may avoid a computationally intensive non-linear operation for coherent transmissions.

The apparatus and methods for the RF exposure compliance for coherent transmissions described herein may provide various advantages. For example, the RF exposure compliance for coherent transmissions may improve wireless communication performance, including, for example, increased throughput, decreased latencies, and/or increased transmission ranges. Such improved performance may be attributable to increased transmit powers allocated for coherent transmission. In some cases, the RF exposure compliance for coherent transmission may facilitate computational efficiencies, for example, due to the application of a less intensive linear operation being performed. Such computational efficiencies may allow the wireless device to devote resources to other signal processing operations, such as digital signal processing, automatic gain control, precoding, and forward error correction, as illustrative, non-limiting examples.

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, etc.), transceivers, and/or RATs (e.g., wireless wide area network (WWAN), wireless local area network (WLAN), short-range communications (e.g., Bluetooth), non-terrestrial communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHz, or 6 GHz).

The techniques described herein may be used for various wireless networks and radio technologies. While aspects may be described herein using terminology commonly associated with 3G, 4G, and/or new radio (NR) (e.g., 5G NR) wireless technologies, aspects of the present disclosure can be applied in other generation-based communication systems and/or to wireless technologies such as 802.11, 802.15, etc.

### Example Wireless Communication Network and Devices

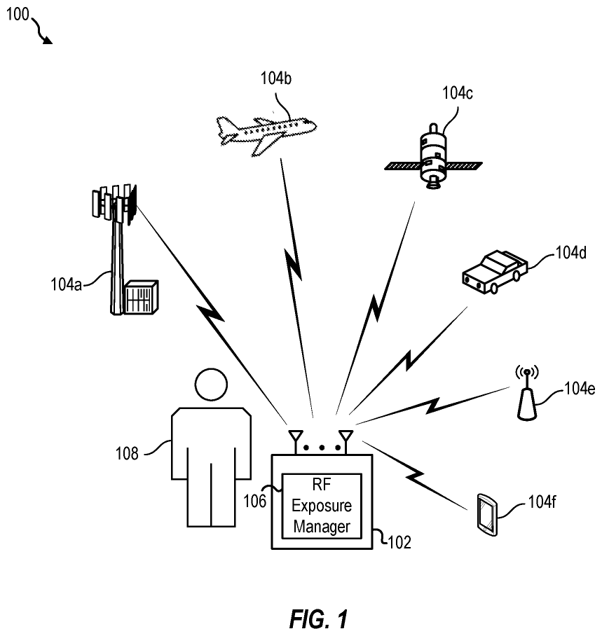

FIG. 1 illustrates an example wireless communication network 100 in which aspects of the present disclosure may be performed. For example, the wireless communication network 100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communication network 100 may include a device-to-device (D2D) communications network or a short-range communications system, such as Bluetooth communications.

As illustrated in FIG. 1, the wireless communication network 100 may include a first wireless device 102 communicating with any of various second wireless devices 104a-f (a second wireless device 104) via any of various RATs, where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, and/or short range communications (e.g., Bluetooth).

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, hand (extremity) exposure, body (body-worn) exposure, hotspot exposure, etc.).

The first wireless device 102 may include any of various wireless communication devices including a user equipment (UE), a wireless station, an access point, a customer-premises equipment (CPE), etc. In certain aspects, the first wireless device 102 includes an RF exposure manager 106 that ensures RF exposure compliance for coherent transmission using a linear operation, in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication network 100 may include terrestrial aspects, such as ground-based network entities (e.g., the base station 104a and/or access point 104c), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.1 lay, 5G in mmWave bands, etc. Note, frequency bands of 24 GHz to 71 GHz are sometimes referred to as a “millimeter wave” (“mmW” or “mm Wave”). Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

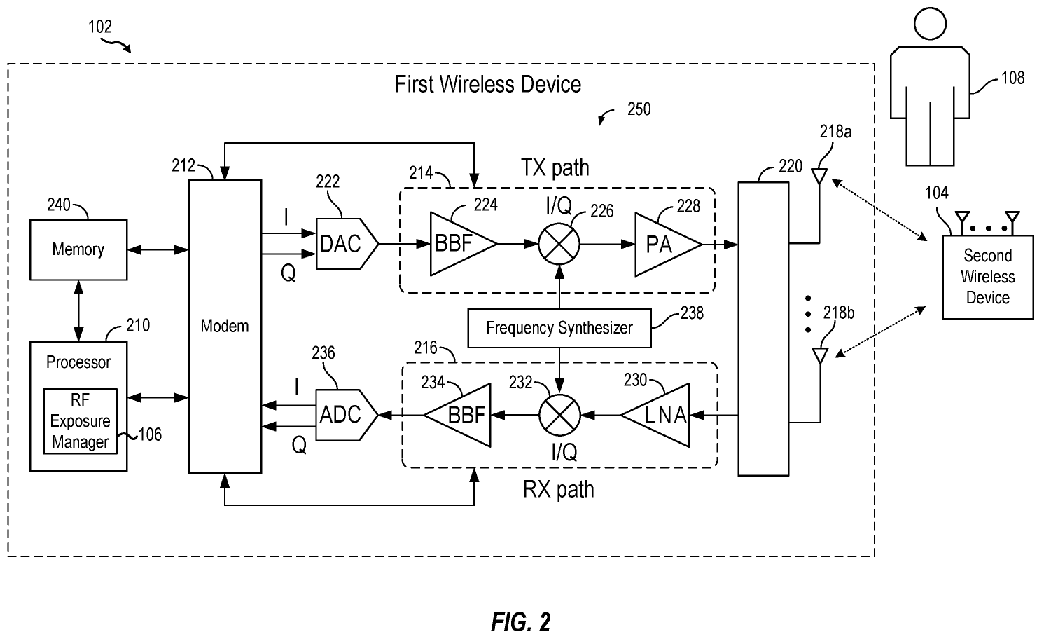

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

In certain aspects, the first wireless device 102 may communicate via multiple-input, multiple-output (MIMO) signals. The first wireless device 102 may transmit more than one signal via multiple antennas 218a, 218b (collectively “the antennas 218”) to the second wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the first wireless device 102 and the second wireless device 104. The MIMO signals may be coherent, for example, synchronized in phase, frequency, and/or transmit power. In some cases, the MIMO signals may exhibit non-linear exposure characteristics, as further described herein.

The RX path 216 may include a low noise amplifier (LNA) 230, a mixer 232, and a BBF 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

Note FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) in the United States specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

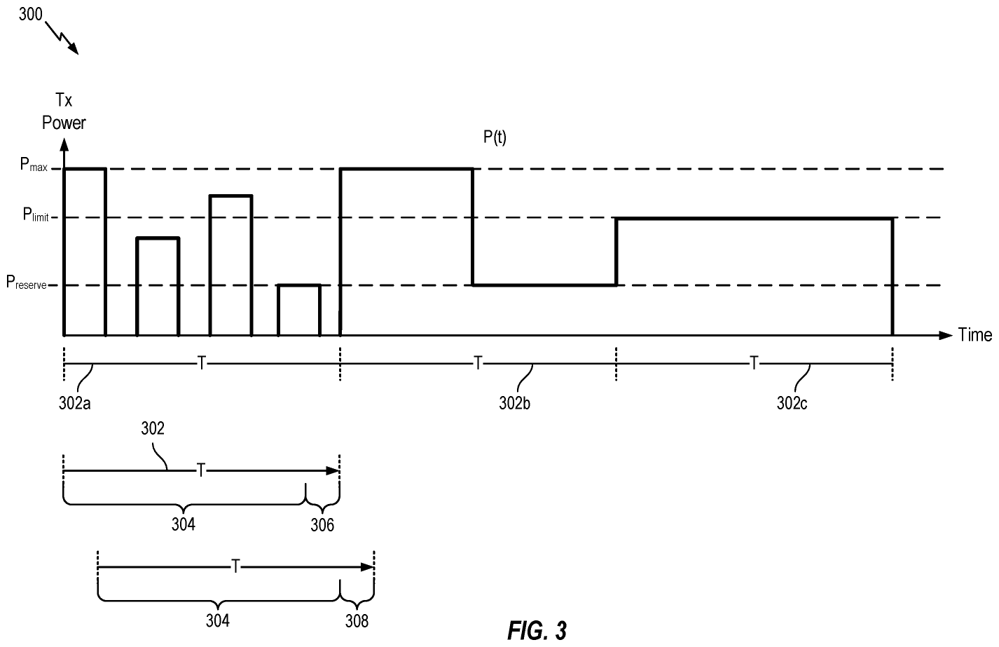

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example RF Exposure Measurements

In certain cases, the RF exposure of a wireless device may be certified with a regulatory agency (e.g., the FCC for the United States or the Innovation, Science and Economic Development Canada (ISED) for Canada). Spatial measurements may be taken with respect to a model (phantom) representing the human body, where the model may be filled with a liquid simulating human tissue. As discussed above, the first wireless device 102 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

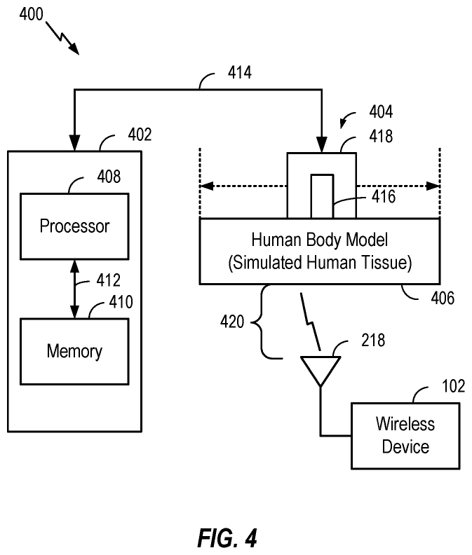

FIG. 4 is a diagram illustrating an example system 400 for measuring RF exposure levels (e.g., values and/or distributions) associated with a wireless communication device (e.g., the first wireless device 102). As shown, the RF exposure measurement system 400 includes a processing system 402, a (robotic) RF probe 404, and a human body model 406. The RF exposure measurement system 400 may take RF measurements at various transmit scenarios (e.g., frequency band, antenna, and/or beam) and/or exposure scenarios (e.g., head exposure, body-worn exposure, extremity (hand) exposure, and/or hotspot exposure) associated with the first wireless device 102. In some examples, these measurements may be used to generate an RF exposure map and assess suitable scaling factors for the transmit powers of the antenna(s) 218 in compliance with one or more RF exposure limits, as further described herein. The first wireless device 102 may emit electromagnetic radiation via the antenna(s) 218 at various transmit powers, and the RF exposure measurement system 400 may take RF measurements via the robotic RF probe 404 (e.g., to determine RF exposure map(s) and/or scaling factors for the antenna(s) 218). Transmit power limits (e.g., Pₗᵢₘᵢₜ) for the various transmit scenarios and/or exposure scenarios associated with the first wireless device 102 may be determined based on the RF measurements and/or exposure maps or scaling factors. Note that while measurements are described as being performed with respect to the wireless device 102, measurements may be taken with respect to a (different) representative device (e.g., a sample device for testing purposes), and then transmit power limits loaded into or otherwise provided or conveyed to the first wireless device 102 (e.g., the devices manufactured for end-users).

In some cases, a test separation distance 420 (or spacing) may be adjusted (increased or decreased) depending on the transmit scenario and/or exposure scenario, where the test separation distance 420 may be the distance between a radiating structure (e.g., the antenna(s) 218) and any part of the human body, in this example, the human body model 406. For example, the test separation distance 420 may be set to 14 millimeters (mm) for body-worn exposure, 0 mm for head exposure, 10 mm for a hotspot exposure, etc. In certain cases, the test separation distance 420 may differ among regions. For example, the test separation distance 420 may be set to 0 mm for body-worn exposure for a particular region, whereas the test separation distance 420 may be set to 14 mm for body-worn exposure for another region, and in some cases, using the same RF exposure limit (e.g., 1.6 W/kg averaged over 1 gram). As the test separation distance 420 may differ among some regions, the corresponding transmit power limits (e.g., Pₗᵢₘᵢₜ) may differ among these regions regardless of whether the same RF exposure limit is applied.

The processing system 402 may include a processor 408 coupled to a memory 410 via a bus 412. The processing system 402 may be a computational device such as a computer. The processor 408 may include a microprocessor, a central processing unit (CPU), a graphics processing unit (GPU), a neural network processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 408 may be in communication with the robotic RF probe 404 via an interface 414 (such as a computer bus interface), such that the processor 408 may obtain RF measurements taken by the robotic RF probe 404 and control the position of the robotic RF probe 404 relative to the human body model 406, for example.

The memory 410 may be configured to store instructions (e.g., computer-executable code) that when executed by the processor 408, cause the processor 408 to perform various operations. For example, the memory 410 may store instructions for obtaining the RF exposure values or distributions associated with various RF exposure/transmit scenarios and/or adjusting the position of the robotic RF probe 404.

The robotic RF probe 404 may include an RF probe 416 coupled to a robotic arm 418. In aspects, the RF probe 416 may be a dosimetric probe capable of measuring RF exposures at various frequencies such as sub-6 GHz bands and/or mmWave bands. The RF probe 416 may be positioned by the robotic arm 418 in various locations (as indicated by the dotted arrows) to capture the electromagnetic radiation emitted by the antenna(s) 218 of the first wireless device 102. The robotic arm 418 may be a six-axis robot capable of performing precise movements to position the RF probe 416 to the location (on the human body model 406) of maximum electromagnetic field generated by the first wireless device 102. In other words, the robotic arm 418 may provide six degrees of freedom in positioning the RF probe 416 with respect to the antenna(s) 218 of the first wireless device 102 and/or the human body model 406.

The human body model 406 may be a specific anthropomorphic mannequin with simulated human tissue. For example, the human body model 406 may include one or more liquids that simulate the human tissue of the head, body, and/or extremities. The human body model 406 may simulate the human tissue for determining the maximum permissible transmission power of the antenna(s) 218 in compliance with various RF exposure limits implemented in various regions.

In certain aspects, the RF exposure levels associated with the first wireless device 102 may be measured without the human body model 406. For example, the RF probe 416 may be an electric- or magnetic-field probe capable of estimating the SAR and/or PD exposure encountered by human tissue in the free-space surrounding the first wireless device 102. While the example depicted in FIG. 4 is described herein with respect to obtaining RF exposure levels with a robotic RF probe to facilitate understanding, aspects of the present disclosure may also be applied to other suitable RF probe architectures, such as using multiple stationary RF probes positioned at various locations along the human body model 406 or free-space.

For a wireless device, a particular Pₗᵢₘᵢₜ may be defined per RAT, frequency band (or carrier, channel, etc.), antenna (or antenna group), and/or RF exposure scenario (e.g., head exposure, body-worn exposure, hand exposure, hotspot exposure, etc.). In some cases, the RF exposure scenario may correspond to a device state index (DSI) or a particular operational state of the device, where the DSI may indicate the device position relative to a human body, e.g., head, hand, body, etc. In certain cases, Pₗᵢₘᵢₜ may correspond to a particular RF exposure target (e.g., SAR or PD), where a separate Pₗᵢₘᵢₜ may be determined for each RF exposure distribution, for example, as described herein with respect to FIG. 4. As an example for SAR exposure, Pₗᵢₘᵢₜₖ for the k^{th} SAR distribution may be given by:

$${P}_{limitk} = T {x}_{SARk} ⋆ SAR\_design \_target / max ( S A {R}_{k} ) \qquad ( 1 )$$

where, max(SARₖ) is the largest SAR value in the k^{th} SAR distribution, Tx_{SARk} is the transmit power applied at the antenna while collecting the SAR distribution, and SAR_design_target may be a target SAR limit. In certain cases, SAR_design_target may be lower than the regulatory SAR limit to account for device uncertainties and/or to budget enough SAR margin to comply with total RF exposure in simultaneous transmission scenarios with other transmitters not included inside the RF exposure time-averaging operation. A regulatory exposure limit may include an RF exposure limit set by a regulatory body (e.g., the FCC) and/or provided by a standards body (e.g., the IEEE or ICNIRP). Thus, the time-averaged SAR exhibited by a wireless device may be kept in compliance with the respective regulatory RF exposure limit by maintaining the time-averaged transmit power for the k^{th} SAR distribution to less than or equal to Pₗᵢₘᵢₜₖ. Pₗᵢₘᵢₜₖ may vary with technology, operating frequency band, transmitting antenna, and/or device position relative to the human body (which may be referred to as “device state index”).

As RF exposure (e.g., SAR and/or PD) is proportional to transmit power, a time-averaging evaluation may perform RF exposure averaging based on past transmit powers by scaling the stored Pₗᵢₘᵢₜₛ as provided in the following expressions:

$$S A {R}_{k} ( t ) = \frac{T {x}_{k} ( t )}{{P}_{limitk}} \cdot SAR\_design \_target \qquad ( 2 a )$$

$$SA {R}_{total} ( t ) = {\sum }_{k = 1}^{m} S A {R}_{k} ( t ) = {\sum }_{k = 1}^{m} \frac{T {x}_{k} ( t )}{{P}_{limitk}} \cdot SAR\_design \_target \qquad ( 2 b )$$

where, SARₖ (t) is the instantaneous SAR value (e.g., largest out of SAR distribution) of the k^{th} transmitter, SARₜₒₜₐₗ(t) is the instantaneous total SAR exhibited by m transmitters, and Pₗᵢₘᵢₜₖ is the Pₗᵢₘᵢₜ corresponding to the k^{th} transmitter transmitting at an instantaneous transmit power of Txₖ(t). As Pₗᵢₘᵢₜₖ definition is based on max(SAR), e.g., the largest SAR value in the k^{th} SAR distribution, SARₜₒₜₐₗ(t) is summing up the largest SAR values among active m transmitters scaled by [Rxₖ(t)/Pₗᵢₘᵢₜₖ] irrespective of the differences in locations of largest SAR in the SAR distributions among the active m transmitters. In other words, Expression (2b) provides an example estimate of total SAR from m transmitters as this expression considers only the largest SAR value of SAR distribution and does not consider the distributions of SAR in space for these transmitters. The time-averaged SAR may be given by the following expression:

$$time . avg . SAR = \frac{1}{T} {\int }_{t - T}^{T} {SAR}_{total} ( t ) dt \leq SAR\_design \_target \qquad ( 3 )$$

where T is the time-averaging (moving) time window associated with the RF exposure limit, for example, as described herein with respect to FIG. 3.

As RF exposure is proportional to transmit power, the time-averaging algorithm may track the time-averaged RF exposure in normalized terms (e.g., relative to Pₗᵢₘᵢₜ) as provided in the following expression:

$$time . avg . normalized . exposure = \frac{1}{T} {\int }_{t - τ}^{T} [ {\sum }_{k = 1}^{m} \frac{{Tx}_{k} ( t )}{{P}_{limitk}} ] dt \leq 1 \qquad ( 4 )$$

For non-coherent signals (e.g., signals transmitting at different frequencies, or where phase is not locked for signals transmitted at the same frequency), the total SAR (SARₜₒₜₐₗ(t)) at any instant in time may be represented as the sum of SARs for each antenna (k) as provided in the following expression:

$${SAR}_{total} ( t ) = {\sum }_{k = 1}^{m} {SAR}_{k} ( t ) \qquad ( 5 )$$

Expressions (5) and (4) may represent the characteristics of exposure associated with non-coherent signals (e.g., a single-input, single-output (SISO) transmission). As further described herein, Expressions (4) and (5) may also be applied to coherent signals using a particular scaling factor that compensates for non-linear components of exposure exhibited by coherent signals (e.g., a MIMO transmission).

For coherent signals (e.g., signals transmitting at the same frequency and phase locked), in the case of MIMO transmitters, where multiple antennas are transmitting at the same frequency, the total SAR (SARₜₒₜₐₗ(t)) may be given by the following expression:

$${SAR}_{total} ( t ) = {[ {\sum }_{k = 1}^{m} \sqrt{{SAR}_{k} ( t )} ]}^{2} = {\sum }_{k = 1}^{m} {SAR}_{k} ( t ) + {{\sum }_{i , j = 1}}_{i \neq j}^{m} \sqrt{{SAR}_{i} ( t )} \sqrt{{SAR}_{j} ( t )} \qquad ( 6 )$$

where each of SARᵢ(t) and SARⱼ(t) is the instantaneous SAR associated with the antenna i and antenna j, respectively.

Here too, for coherent signals, the time-averaging algorithm may track the time-averaged RF exposure for coherent signals in normalized terms (e.g., relative to Pₗᵢₘᵢₜ) as provided in the following expression:

$$time . avg . normalized . exposure = \frac{1}{T} {\int }_{t - τ}^{T} [ {\sum }_{k = 1}^{m} \frac{{Tx}_{k} ( t )}{{P}_{limitk}} ] dt \leq 1 \qquad ( 7 )$$

where the exponential and square root operations involve non-linear operations. The non-linear operations may be computationally intensive for certain devices, such as a portable computational device including a smartphone or tablet. As the time-averaging evaluation may be repeatedly updated on a rolling basis (e.g., every 500 milliseconds), a wireless device may not be capable of completing the non-linear operation in every iteration associated with the time-averaging evaluation. In some cases, the non-linear operation may use additional power consumption and/or excessive computational resources that could be allocated to other signal processing operations, such as digital signal processing, automatic gain control, precoding, forward error correction, etc.

### Example Linear Computation of Radio Frequency Exposure for Coherent Transmission

Aspects of the present disclosure provide apparatus and methods for RF exposure compliance for coherent transmissions using a linear computation. Transmit power limits (e.g., Pₗᵢₘᵢₜ) for separate antennas may be scaled to account for the non-linear effects of a coherent transmission on RF exposure, as described herein with respect to Expressions (6) and (7). The wireless device may apply a linear operation, using the scaled transmit power limits, in determining the time-averaged exposure for coherent transmission. For example, the wireless device may determine the time-averaged exposure based on a sum of transmit powers over time for each of the antennas without the non-linear component described herein with respect to Expressions (6) and (7). Such a time-averaging evaluation may avoid a computationally intensive non-linear operation for coherent transmissions.

The apparatus and methods for the RF exposure compliance for coherent transmissions described herein may provide various advantages. For example, the RF exposure compliance for coherent transmissions may improve wireless communication performance, including, for example, increased throughput, decreased latencies, and/or increased transmission ranges. Such improved performance may be attributable to increased transmit powers allocated for coherent transmission. In some cases, the RF exposure compliance for coherent transmission may facilitate computational efficiencies, for example, due to the application of a less intensive linear operation being performed. Such computational efficiencies may allow the wireless device to devote resources to other signal processing operations, such as digital signal processing, automatic gain control, precoding, forward error correction, as illustrative, non-limiting examples.

As described herein with respect to Expressions (6) and (7), the total SAR and time-averaged SAR encountered for coherent transmissions may exhibit a non-linear component, such as square-root operation and/or an exponential. For coherent signals in a 2×2 MIMO transmission, the total instantaneous SAR based on Expression (6) can be expressed as:

$$MIMO . SAR ( t ) = {SAR}_{1} ( t ) + {SAR}_{2} ( t ) + {2}^{*} sqrt [ {SAR}_{1} ( t ) * {SAR}_{2} ( t ) ] \qquad ( 8 a )$$

where SAR₁(t) and SAR₂(t) are the instantaneous SARs (e.g., the largest SAR value associated with the respective distributions or a single SAR value or measurement when distributions are not utilized or considered) exhibited by a first antenna (e.g., the first antenna 218a) and a second antenna (e.g., the second antenna 218b), respectively. Therefore, MIMO.SAR(t) computed using Expression (8a) may produce a higher value than the sum of SAR₁(t) and SAR₂(t). However, if Expression (8a) is performed using SAR distributions (varying with location (x,y,z)).then the maximum value out of all locations of SAR distribution may be expressed as:

$$MIMO . SAR ( t ) = max \{ MIMO . SAR ( x , y , z , t ) \} = max \{ {SAR}_{1} ( x , y , z , t ) + {SAR}_{2} ( x , y , z , t ) + 2 * sqrt [ {SAR}_{1} ( x , y , z , t ) * {SAR}_{2} ( x , y , z , t ) ] \} \qquad ( 8 b )$$

Given the relationship in Expression (8b), MIMO.SAR(t) could be higher than, lower than, or equal to the sum of SAR₁(t) and SAR₂(t) depending on the locations of the largest SAR value in respective SAR distributions SAR₁(x,y,z,t) and SAR₂(x,y,z,t).

In certain aspects, the non-linear component of the RF exposure encountered in MIMO transmissions can be compensated for using a scaling factor (backoff_for_MIMO, e.g., backoff in Pₗᵢₘᵢₜₛ), as further described herein. It will be appreciated that while the scaling factor is abbreviated as a backoff, the scaling factor may represent an adjustment (e.g., increase or decrease). For example, the total SAR for a 2×2 MIMO transmission can be expressed as follows in terms of the scaling factor:

$$MIMO . SAR ( t ) = [ SAR 1 ( t ) + SAR 2 ( t ) ] / backoff\_for \_MIMO \qquad ( 9 )$$

In certain aspects, the scaling factor may be determined using SAR measurements obtained in various transmission modes (e.g., MIMO mode and single transmitter modes) as described herein with respect to FIG. 4. For example, SAR measurements may be obtained for when each antenna associated with a MIMO transmission is used individually and for when the respective antennas are used in the MIMO mode. Thus, in a 2×2 MIMO mode, at least three SAR measurements may be obtained: a measurement for each antenna and a measurement for the MIMO transmission. In certain aspects, the SAR measurement may correspond to a SAR distribution and/or a particular SAR level associated with a SAR distribution, e.g., the highest SAR value in the SAR distribution.

In certain cases, the wireless device may apply Pₗᵢₘᵢₜ for both non-coherent transmissions and coherent transmissions (e.g., MIMO) after applying a suitable backoff (e.g., including the scaling factor described herein) to the Pₗᵢₘᵢₜ determined with the SAR design target as described herein with respect to Expressions (3) and (4). For a given SAR design target, the Plinit (corresponding to the SAR design target) in Expression (4) may be replaced with a scaled Pₗᵢₘᵢₜ, where the scaled Pₗᵢₘᵢₜ may be equal to the product of the Pₗᵢₘᵢₜ associated with the SAR design target and a backoff factor (e.g., scaled_Pₗᵢₘᵢₜ=Pₗᵢₘᵢₜ*backoff, where backoff ≤1.0), to ensure the RF exposure compliance for both non-coherent transmissions and coherent transmissions (e.g., MIMO). In certain aspects, such a scaled Pₗᵢₘᵢₜ may be used for non-coherent and coherent transmissions.

In certain aspects, the scaling factor may be applied when certain conditions are satisfied. For example, the scaling factor (backoff_for_MIMO) may only be less than or equal to 1.0 to ensure non-coherent (e.g., SISO) transmissions are also compliant using Expression (4). Therefore, the scaling factor may be applied when the SAR exhibited by the MIMO transmission exceeds the sum of the individual RF exposures associated with the antennas in a MIMO transmission. In certain cases, the scaling factor may be applied to antennas in the same antenna group, as further described herein. The scaling factor (backoff_for_MIMO) may be applied, when the following condition is satisfied (for a 2×2 MIMO scenario):

meas.MIMO.SAR>meas.SAR₁+meas.SAR₂

where meas. MIMO.SAR represents measured SAR with both Tx1 and Tx2 transmitting at P_test level (e.g., in a MIMO transmission), meas.SAR₁ represents measured SAR with only Tx1 transmitting at P_test level (e.g., in a SISO transmission), and meas.SAR₂ represents measured SAR with only Tx2 transmitting at P_test level (e.g., in a SISO transmission).

The scaling factor (backoff_for_MIMO) may be determined according to the following expression:

$$backoff\_for \_MIMO = ( meas . SAR 1 + meas . SAR 2 ) / ( meas . MIMO . SAR ) \qquad ( 10 )$$

The scaling factor may not be applied (or the scaling factor is equal to 1), when the following condition is satisfied (for a 2×2 MIMO scenario):

$$meas . MIMO . SAR \leq SAR 1 + meas . SAR 2 \qquad ( 11 )$$

In certain aspects, the scaling factor may be determined according to the following expression (for a 2×2 MIMO example):

$$backoff\_for \_MIMO ( i , j ) = min \{ ( meas . SARi + meas . SARj ) / ( meas . MIMO . SARij ) , 1 \} \qquad ( 12 )$$

The scaling factor may be determined for all (or some of the) antenna pair combinations that support 2×2 MIMO. For example, if antenna “k” supports MIMO transmission on the device with N other antennas, the scaling factor for antenna “k” may be determined as:

$$backoff\_for \_MIMO \_antenna \_k = min \{ backoff\_for \_MIMO ( k , j ) , j = 1 to N , j \neq k \} \qquad ( 13 )$$

The scaling factor may also not be applied or may be set to 1 in scenarios where MIMO.SAR(t) in Expression (8b) is less than the sum of SAR1(t) and SAR2(t) of individual transmitters. This may occur in scenarios where MIMO antennas are sufficiently far apart physically on the device (e.g., when the antennas are in different antenna groups). In such cases, the RF exposure for the MIMO transmission is equivalent to the largest SAR across the device, e.g., MIMO.SAR=max{MIMO.SAR(x,y,z)}=max{[Σₖ₌₁²\sqrt{SARₖ(x,y,z)}]²}=max{SARₖ(x,y,z)}. The scaling factor may not be applied or may be set to 1 in such cases as there is less overlap in SAR distributions for sufficiently far apart antennas.

In certain cases, the scaling factor may be applied to antennas in the same antenna group. If the MIMO antennas are spread across different antenna groups, the scaled Pₗᵢₘᵢₜₛ may be applied separately on the subsets per antenna group. In a 4×4 MIMO example, three antennas may be in the same antenna group, and a fourth antenna may be in a different antenna group. The three antennas in the same antenna group may apply the scaled Pₗᵢₘᵢₜ if the SAR exhibited by the MIMO transmission exceeds the sum of the individual RF exposures associated with the antennas in a MIMO transmission as described herein, and the fourth antenna may apply the Pₗᵢₘᵢₜ as determined according to Expression (1), for example. An antenna group may be a group of one or more antennas where the RF exposure associated with such antennas may be tracked and evaluated as a group. The RF exposure associated with antenna groups may be treated as being mutually exclusive of each other among the antenna groups. Such RF exposure treatment for the antenna groups may be due to the physical arrangement of the antennas in the antenna groups.

While the examples provided herein are described with respect to 2×2 MIMO to facilitate understanding, aspects of the present disclosure may also be applied to any MIMO configurations or multi-output transmission modes, such as 4×4 MIMO or any other number (m) of MIMO pairs, as illustrative, non-limiting examples. For example, the scaling factor may be determined according to the following expression:

$$backoff\_for \_MIMO = min \{ ( {\sum }_{k = 1}^{m} meas . {SAR}_{k} ) / ( meas . mXm . SAR ) , 1 \} \qquad ( 14 )$$

After determining the scaling factors for each antenna that supports MIMO transmission mode, a scaled transmit power limit (backed.off.Plimitₖ) may be determined as follows:

$$backed . off . {Plimit}_{k} = {Plimit}_{k} * backoff\_for \_MIMO \_antenna \_k \qquad ( 15 )$$

Here, the scaled Pₗᵢₘᵢₜ (represented by backed.off.Plimitₖ) may be determined for each combination of RAT, frequency band, antenna (or antenna group), and/or exposure scenario that supports MIMO transmissions, and may always be used or may selectively be used (e.g., when in a coherent transmission scenario, as described below). For antennas that do not apply the scaling factor as described above, the respective Pₗᵢₘᵢₜₛ may remain unchanged, such that, for example, only one Pₗᵢₘᵢₜ for each combination of RAT, frequency band, antenna (or antenna group), and/or exposure scenario may be stored or available.

As the scaled Pₗᵢₘᵢₜ compensates for the non-linear component of the RF exposure for coherent transmission, the time-averaged RF exposure may be determined in normalized terms according to the following expression:

$$time . avg . normalized . exposure = \frac{1}{T} {\int }_{t - τ}^{T} [ {\sum }_{k = 1}^{m} \frac{{Tx}_{k} ( t )}{backed . off . {P}_{limitk}} ] dt \leq 1 \qquad ( 16 )$$

where backed.off.Plimit may be determined according to Expression (15).

In certain aspects, the scaled Pₗᵢₘᵢₜ may be applied for coherent signals and non-coherent signals. As the scaled Pₗᵢₘᵢₜ may be reduced compared to the Pₗᵢₘᵢₜ associated with non-coherent signals, the scaled Pₗᵢₘᵢₜ may ensure RF exposure compliance regardless of whether the scaled Pₗᵢₘᵢₜ is applied for coherent signals and non-coherent signals.

For certain aspects, the wireless device may select among the scaled Pₗᵢₘᵢₜ for coherent signals and the Pₗᵢₘᵢₜ for non-coherent signals depending on whether coherent signals or non-coherent signals are being transmitted. The wireless device may store both sets of Pₗᵢₘᵢₜₛ and select the respective Pₗᵢₘᵢₜ in response to the type of transmission either being coherent or non-coherent. The time-averaging algorithm may apply the non-coherent Pₗᵢₘᵢₜ for active antenna(s) transmitting non-coherent signals and apply the scaled Pₗᵢₘᵢₜ for active antennas that are transmitting coherent signals (e.g., MIMO). In certain aspects, the wireless device may store scaled Pₗᵢₘᵢₜₛ for each of the supported MIMO antenna configurations (e.g., all or some supported antenna pairs in 2×2 MIMO scenario, all or some supported antenna quadruplets in 4×4 MIMO scenario, etc.) to apply during coherent transmission, and in such aspects, there may be no restriction on the value of scaling factor (e.g., the scaling factor can be greater than, less than or equal to 1.0).

In certain aspects, the wireless device may apply a transmit power limit for the antennas belonging to a MIMO combination. For example, the MIMO transmit power limit may be expressed as:

mimoPlimit(i,j)=TX_{SAR(i,j)}*SAR design target/max(meas.MIMO.SAR_{(i,j)})

In such cases, the summation of individual antenna transmit powers,

$$[ {\sum }_{k = 1}^{m} \frac{{Tx}_{k} ( t )}{backed . off . {P}_{limitk}} ] ,$$

may be replaced with

$$[ \frac{T {x}_{( 1 , 2 , … , m )} ( t )}{{mimoP}_{limit} ( 1 , 2 , … , m )} ] ,$$

where Tx(1, 2, . . . ,m) is the transmit power for all the “m” MIMO transmitters in a m×m MIMO configuration belonging to the same antenna group. In some cases, mimoPlimits may be determined for all supported antenna combinations in all supported MIMO configurations. In certain aspects, instead of using a separate set of Pₗᵢₘᵢₜₛ for the MIMO configurations, the same Pₗᵢₘᵢₜ could be used (as for SISO), but the scaling factor (e.g., backoff_for_MIMO) may be selectively applied in response to either coherent signals or non-coherent signals being transmitted. Such an implementation may reduce storage size and complexity as a single set of Pₗᵢₘᵢₜₛ may be used with the appropriate scaling factor.

For certain aspects, there might be situations where even if MIMO or other coherent transmission is being used, the backoff (either in the form of a backed off Pₗᵢₘᵢₜ or multiplying a consistent Pₗᵢₘᵢₜ by a backoff factor) may not be applied, for example, when Expression (11) is satisfied. Therefore, the determination of whether or not to use a Pₗᵢₘᵢₜ or backoff factor might not be based exclusively on whether MIMO (or other coherent transmission) is being used, but rather might be based on whether a particular MIMO (or other coherent transmission) scenario is in use that triggers the scaled Pₗᵢₘᵢₜ or the unscaled Pₗᵢₘᵢₜ. In such cases where the SISO Pₗᵢₘᵢₜ is applicable, the backoff may be set to 1, or the MIMO Pₗᵢₘᵢₜ may be set to the same value as the SISO Pₗᵢₘᵢₜ for that particular MIMO scenario such that the device may perform similar operations each time (e.g., instead determining whether to apply a backoff, the device applies a particular backoff each time, and the backoff may be 1 or another value).

While the examples provided herein are described with respect to SAR to facilitate understanding, aspects of the present disclosure may also be applied to other suitable metrics of RF exposure, such as PD.

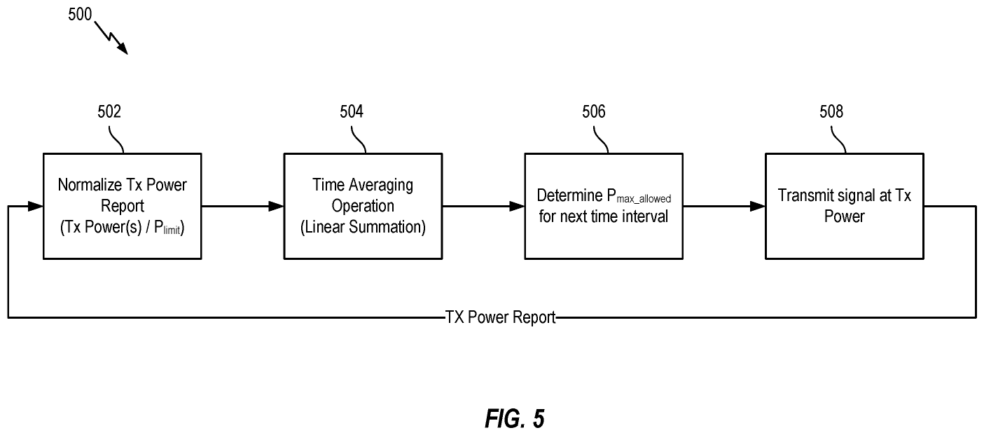

FIG. 5 is a flow diagram illustrating example operations 500 for ensuring compliance with a time-averaged RF exposure regulatory limit. The operations 500 may be performed, for example, by a wireless device (e.g., the first wireless device 102).

The operations 500 may optionally begin, at block 502, where the wireless device may obtain the transmit power(s) used for a particular time interval (e.g., the time interval 306) in a time window (T) associated with a time-averaged RF exposure limit. The wireless device may determine a normalized power report of the past transmit power(s) relative to Pₗᵢₘᵢₜ, for example, as described herein with respect to Expression (16),

$$\frac{{Tx}_{k} ( t )}{backed . off . {P}_{limitk}} .$$

In certain aspects, the wireless device may apply the scaled Pₗᵢₘᵢₜ in response to transmitting coherent signals, or may apply a backoff to the past transmit power(s) when transmitted with or transmitting coherent signals. For certain aspects, the wireless device may apply the scaled Pₗᵢₘᵢₜ for both non-coherent and coherent signals.

The transmit power may be obtained from a radio (e.g., the radio 250) that applied the transmit power(s) in the time interval. In certain aspects, the processor 210 and/or the modem 212 may obtain (or access) the transmit power used for the particular time interval from the radio 250. For example, the processor 210 and/or the modem 212 may track the transmit power(s) used by the transmit (TX) path 214 over time as reported by the radio 250 in a transmit power report to the processor 210 and/or the modem 212. A transmit power report of the past transmit powers (e.g., the past transmit powers used in the time interval 306) may be representative of actual transmit power(s) within an expected device uncertainty.

At block 504, the wireless device may perform a time averaging operation based on the scaled Pₗᵢₘᵢₜ or the use of a scaling factor. For example, the wireless device may determine the time-averaged RF exposure using a linear operation—for example, according to Expression (16)—due to the scaled Pₗᵢₘᵢₜ or the application of a scaling factor compensating for the non-linear effects of coherent signals. The wireless device may determine a normalized exposure margin allowed for the next time interval (e.g., the time interval 308) in the time window (T) such that the time average of the normalized power report and the exposure margin for the next time interval satisfy the RF exposure limit or design target. In certain aspects, the exposure margin may be the maximum RF exposure that the wireless device can produce and satisfy the RF limit or design target. The normalized exposure margin may be the percentage of exposure remaining with respect to the normalized power report and the scaled RF exposure limit or design target. For example, the normalized scaled RF exposure design target may be satisfied when the time average of the normalized power report and the exposure margin for the next time interval is less than or equal to one (e.g., the normalized RF exposure limit or design target).

At block 506, the wireless device may determine the maximum allowed transmit power (P_{max_allowed}) for the next time interval (e.g., the time interval 308). For example, the maximum allowed transmit power (P_{max_allowed}) may be equal to the product of the normalized exposure margin and Pₗᵢₘᵢₜ.

At block 508, the wireless device may provide the maximum allowed transmit power to transceiver circuitry (e.g., the radio 250). For example, the radio 250 may obtain the maximum allowed transmit power as digital RF information (e.g., a particular gain index associated with an output power of the TX path 214), and the radio 250 may control the gains applied to circuitry in the transmit path to output a signal (e.g., an analog RF signal) at the transmit power associated with the digital RF information. The radio 250 may provide the actual transmit power used as a transmit power report to the processor 210 and/or the modem 212 for determining the transmit power to be used in the next time interval.

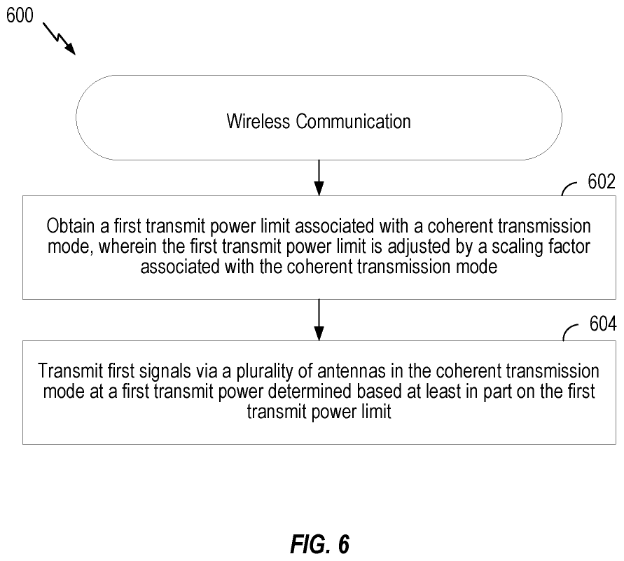

FIG. 6 is a flow diagram illustrating example operations 600 for wireless communication. The operations 600 may be performed, for example, by a wireless device (e.g., the first wireless device 102 in the wireless communication network 100). The operations 600 may be implemented as software components that are executed and run on one or more processors (e.g., the processor 210 and/or the modem 212 of FIG. 2). Further, the transmission and/or reception of signals by the wireless device in the operations 600 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 600 may optionally begin, at block 602, where the wireless device may obtain a first transmit power limit (e.g., backed.off.Plimitₖ) associated with a coherent transmission mode, where the first transmit power limit is adjusted by a scaling factor (e.g., backoff_for_MIMO) associated with the coherent transmission mode. The first transmit power limit may include a maximum time-averaged transmit power associated with an RF exposure limit. The scaling factor may be a ratio of a sum of RF exposure levels associated with single antenna transmissions to an RF exposure level associated with a MIMO transmission. The coherent transmission mode may include a MIMO transmission mode. In certain aspects, to obtain the first transmit power limit, the wireless device may select the first transmit power limit among a plurality of transmit power limits in response to detecting the wireless device is transmitting coherent signals.

At block 604, the wireless device may transmit first signals via a plurality of antennas in the coherent transmission mode at a first transmit power determined based at least in part on the first transmit power limit. The plurality of antennas may be in an antenna group among a plurality of antenna groups. The RF exposure associated with the antenna groups may be treated as being mutually exclusive of each other among the antenna groups.

The wireless device may transmit a second signal via at least one of the plurality of antennas in a non-coherent transmission mode at a second transmit power determined based at least in part on the first transmit power limit. The non-coherent transmission mode may be a SISO transmission mode.

The wireless device may obtain a second transmit power limit associated with a non-coherent transmission mode. The wireless device may transmit a second signal via at least one of the plurality of antennas in the non-coherent transmission mode at a second transmit power determined based at least in part on the second transmit power limit, where the second transmit power limit differs from the first transmit power limit. The first transmit power limit may be equal to a product of the second transmit power limit and the scaling factor.

The wireless device may determine a time-averaged exposure based on one or more transmit powers and the first transmit power limit. The wireless device may determine the first transmit power based on the time-averaged exposure satisfying an RF exposure limit. To determine the time-averaged exposure, the wireless device may perform a linear computation of the time-averaged exposure based on the first transmit power limit, for example, according to Expression (16). To determine the time-averaged exposure, the wireless device may determine a sum of the one or more transmit powers normalized by the first transmit power limit.

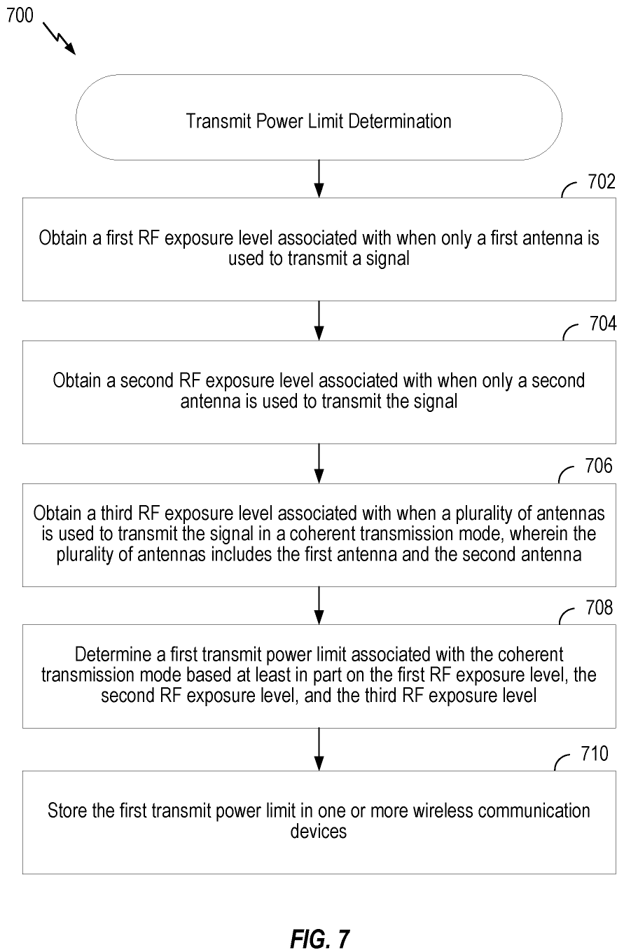

FIG. 7 is a flow diagram illustrating example operations 700 for determining a transmit power limit for RF exposure compliance. The operations 700 may be performed, for example, by a processing system including an RF exposure measurement system (e.g., the RF exposure measurement system 400) and/or one or more computational devices, such as one or more computers.

The operations 700 may optionally begin, at block 702, where the processing system may obtain a first RF exposure level associated with when only a first antenna is used to transmit a signal.

At block 704, the processing system may obtain a second RF exposure level associated with when only a second antenna is used to transmit the signal.

At block 706, the processing system may obtain a third RF exposure level associated with when a plurality of antennas is used to transmit the signal in a coherent transmission mode, wherein the plurality of antennas includes the first antenna and the second antenna.

At block 708, the processing system and/or another computational device may determine a backoff factor and/or first transmit power limit associated with the coherent transmission mode based at least in part on the first RF exposure level, the second RF exposure level, and the third RF exposure level.

At block 710, the processing system and/or another computational device may store the backoff factor and/or the first transmit power limit in one or more wireless communication devices. The first transmit power limit comprises a maximum time-averaged transmit power associated with an RF exposure limit. The first transmit power limit may be adjusted by a scaling factor associated with the coherent transmission mode. The first transmit power limit may be determined as a product of a second transmit power limit and the scaling factor.

The processing system may configure the one or more wireless communication devices to apply the first transmit power limit in ensuring compliance with an RF exposure limit when transmitting via the plurality of antennas in the coherent transmission mode.

To determine the first transmit power limit, the processing system may determine a sum of at least the first RF exposure level and the second RF exposure level. The processing system may determine a ratio of the sum to the third RF exposure level. The processing system may determine the first transmit power limit as a product of the ratio and a second transmit power limit associated with at least one of the plurality of antennas. To determine the first transmit power limit, the processing system may determine the first transmit power limit in response to determining that the third RF exposure level satisfies a criterion associated with the first RF exposure level and the second RF exposure level. The criterion may be satisfied when the third RF exposure level is greater than the sum.

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

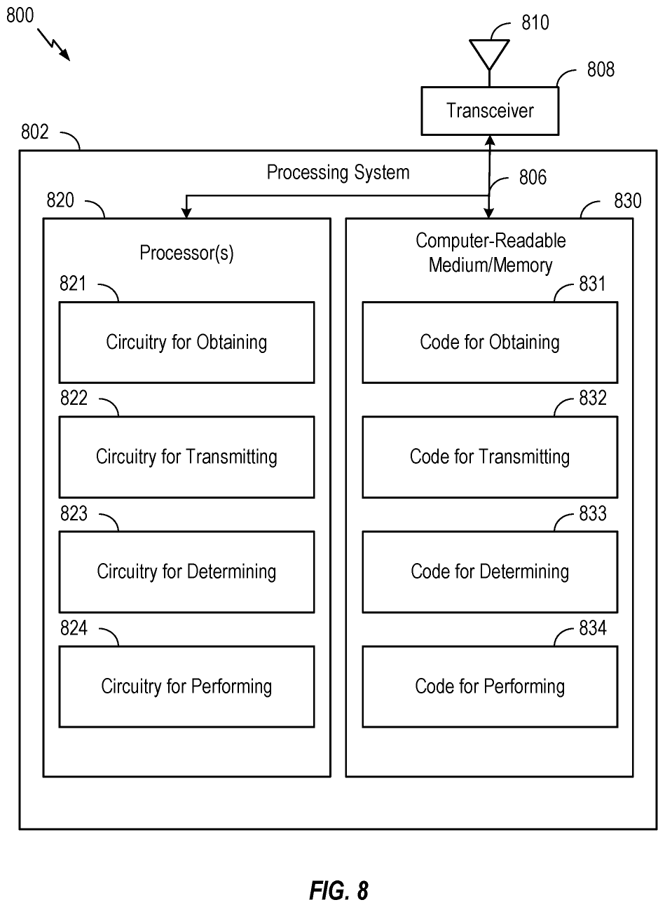

FIG. 8 depicts aspects of an example communications device 800. In some aspects, communications device 800 is a wireless communication device, such as the first wireless device 102 described above with respect to FIGS. 1 and 2.

The communications device 800 includes a processing system 802 coupled to a transceiver 808 (e.g., a transmitter and/or a receiver). The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes one or more processors 820. In various aspects, the one or more processors 820 may be representative of any of the processor 210 and/or the modem 212, as described with respect to FIG. 2. The one or more processors 820 are coupled to a computer-readable medium/memory 830 via a bus 806. In certain aspects, the computer-readable medium/memory 830 is configured to store instructions (e.g., computer-executable code) that when executed by the one or more processors 820, cause the one or more processors 820 to perform the operations 600 described with respect to FIG. 6, or any aspect related to the operations described herein. Note that reference to a processor performing a function of communications device 800 may include one or more processors performing that function of communications device 800.

In the depicted example, computer-readable medium/memory 830 stores code (e.g., executable instructions) for obtaining 831, code for transmitting 832, code for determining 833, code for performing 834, or any combination thereof. Processing of the code 831-834 may cause the communications device 800 to perform the operations 600 described with respect to FIG. 6, operations 700 described with respect to FIG. 7, or any aspect related to operations described herein.

The one or more processors 820 include circuitry configured to implement (e.g., execute) the code stored in the computer-readable medium/memory 830, including circuitry for obtaining 821, circuitry for transmitting 822, circuitry for determining 823, circuitry for performing 824, or any combination thereof. Processing with circuitry 821-824 may cause the communications device 800 to perform the operations 600 described with respect to FIG. 6, operations 700 described with respect to FIG. 7, or any aspect related to operations described herein.

Various components of the communications device 800 may provide means for performing the operations 600 described with respect to FIG. 6, operations 700 described with respect to FIG. 7, or any aspect related to operations described herein. For example, means for transmitting, sending or outputting for transmission may include the TX path 214 and/or antenna(s) 218 of the first wireless device 102 illustrated in FIG. 2 and/or transceiver 808 and antenna 810 of the communications device 800 in FIG. 8. Means for receiving or obtaining may include the RX path 216 and/or antenna(s) 218 of the first wireless device illustrated in FIG. 2 and/or transceiver 808 and antenna 810 of the communications device 800 in FIG. 8. Means for obtaining, means for determining, means for storing, and/or means for performing may include a processor, such as the processor 210 and/or modem 212 depicted in FIG. 2 and/or the processor(s) 820 in FIG. 8. Means for storing may additionally or alternatively include one or more memories, such as the memory 240 portrayed in FIG. 2 and/or the computer-readable medium/memory 830 in FIG. 8.

### EXAMPLE ASPECTS

Implementation examples are described in the following numbered clauses:

Aspect 1: A method of wireless communication by a wireless device, comprising: obtaining a first transmit power limit associated with a coherent transmission mode, wherein the first transmit power limit is adjusted by a scaling factor associated with the coherent transmission mode; and transmitting first signals via a plurality of antennas in the coherent transmission mode at a first transmit power determined based at least in part on the first transmit power limit.

Aspect 2: The method of Aspect 1, wherein: the plurality of antennas is in an antenna group among a plurality of antenna groups; and radio frequency (RF) exposure associated with the antenna group is treated as being mutually exclusive of RF exposure associated with each other antenna group among the plurality of antenna groups.

Aspect 3: The method of Aspect 1 or 2, further comprising transmitting a second signal via at least one of the plurality of antennas in a non-coherent transmission mode at a second transmit power determined based at least in part on the first transmit power limit.

Aspect 4: The method of Aspect 1 or 2, further comprising: obtaining a second transmit power limit associated with a non-coherent transmission mode; and transmitting a second signal via at least one of the plurality of antennas in the non-coherent transmission mode at a second transmit power determined based at least in part on the second transmit power limit, wherein the second transmit power limit differs from the first transmit power limit.

Aspect 5: The method of Aspect 3 or 4, wherein the first transmit power limit is equal to a product of the second transmit power limit and the scaling factor.

Aspect 6: The method according to any of Aspects 1-5, wherein the scaling factor is a ratio of a sum of radio frequency (RF) exposure levels associated with single antenna transmissions to an RF exposure level associated with a multiple-input, multiple-output (MIMO) transmission.

Aspect 7: The method according to any of Aspects 3-6, wherein the non-coherent transmission mode comprises a single-input, single-output (SISO) transmission mode.

Aspect 8: The method according to any of Aspects 1-7, wherein the coherent transmission mode comprises a multiple-input, multiple-output (MIMO) transmission mode.

Aspect 9: The method according to any of Aspects 1-8, further comprising: determining a time-averaged exposure based on one or more transmit powers and the first transmit power limit; and determining the first transmit power based on the time-averaged exposure satisfying a radio frequency (RF) exposure limit.

Aspect 10: The method of Aspect 9, wherein determining the time-averaged exposure comprises performing a linear computation of the time-averaged exposure based on the first transmit power limit.

Aspect 11: The method of Aspect 9 or 10, wherein determining the time-averaged exposure comprises determining a sum of the one or more transmit powers normalized by the first transmit power limit.

Aspect 12: The method according to any of Aspects 1-11, wherein the first transmit power limit comprises a maximum time-averaged transmit power associated with an RF exposure limit.

Aspect 13: The method according to any of Aspects 1-2 and 4-12, wherein obtaining the first transmit power limit comprises selecting the first transmit power limit among a plurality of transmit power limits in response to detecting the wireless device is transmitting coherent signals.

Aspect 14: The method according to any of Aspects 1-2 and 4-12, wherein obtaining the first transmit power limit comprises selecting the first transmit power limit among a plurality of transmit power limits in response to detecting the wireless device is transmitting in the coherent transmission mode.

Aspect 15: A method of determining a transmit power limit for radio frequency (RF) exposure compliance, comprising: obtaining a first RF exposure level associated with when only a first antenna is used to transmit a signal; obtaining a second RF exposure level associated with when only a second antenna is used to transmit the signal; obtaining a third RF exposure level associated with when a plurality of antennas is used to transmit the signal in a coherent transmission mode, wherein the plurality of antennas includes the first antenna and the second antenna; determining a first transmit power limit associated with the coherent transmission mode based at least in part on the first RF exposure level, the second RF exposure level, and the third RF exposure level; and storing the first transmit power limit in one or more wireless communication devices.

Aspect 16: The method of Aspect 15, further comprising configuring the one or more wireless communication devices to apply the first transmit power limit in ensuring compliance with an RF exposure limit when transmitting via the plurality of antennas in the coherent transmission mode.

Aspect 17: The method of Aspect 15 or 16, wherein determining the first transmit power limit comprises: determining a sum of at least the first RF exposure level and the second RF exposure level; determining a ratio of the sum to the third RF exposure level; and determining the first transmit power limit as a product of the ratio and a second transmit power limit associated with at least one of the plurality of antennas.

Aspect 18: The method according to any of Aspects 15-17, wherein determining the first transmit power limit comprises determining the first transmit power limit in response to determining that the third RF exposure level satisfies a criterion associated with the first RF exposure level and the second RF exposure level.

Aspect 19: The method of Aspect 18, wherein the criterion is satisfied when the third RF exposure level is greater than the sum.

Aspect 20: The method according to any of Aspects 15-19, wherein the first transmit power limit comprises a maximum time-averaged transmit power associated with an RF exposure limit.

Aspect 21: The method according to any of Aspects 15-20, wherein the first transmit power limit is adjusted by a scaling factor associated with the coherent transmission mode.

Aspect 22: The method of Aspect 21, wherein the first transmit power limit is determined as a product of a second transmit power limit and the scaling factor.

Aspect 23: An apparatus for wireless communication, comprising: one or more memories collectively storing executable instructions; and one or more processors coupled to the one or more memories, the one or more processors being collectively configured to execute the executable instructions to cause the apparatus to: obtain a first transmit power limit associated with a coherent transmission mode, wherein the first transmit power limit is adjusted by a scaling factor associated with the coherent transmission mode, and control transmission of first signals via a plurality of antennas in the coherent transmission mode at a first transmit power determined based at least in part on the first transmit power limit.

Aspect 24: An apparatus for determining a transmit power limit for radio frequency (RF) exposure compliance, comprising: one or more memories collectively storing executable instructions; and one or more processors coupled to the one or more memories, the one or more processors being collectively configured to execute the executable instructions to cause the apparatus to: obtain a first RF exposure level associated with when only a first antenna is used to transmit a signal, obtain a second RF exposure level associated with when only a second antenna is used to transmit the signal, obtain a third RF exposure level associated with when a plurality of antennas is used to transmit the signal in a coherent transmission mode, wherein the plurality of antennas includes the first antenna and the second antenna, determine a first transmit power limit associated with the coherent transmission mode based at least in part on the first RF exposure level, the second RF exposure level, and the third RF exposure level, and store the first transmit power limit in one or more wireless communication devices.

Aspect 25: An apparatus for wireless communication, comprising: means for obtaining a first transmit power limit associated with a coherent transmission mode, wherein the first transmit power limit is adjusted by a scaling factor associated with the coherent transmission mode; and means for transmitting first signals via a plurality of antennas in the coherent transmission mode at a first transmit power determined based at least in part on the first transmit power limit.

Aspect 26: An apparatus for determining a transmit power limit for radio frequency (RF) exposure compliance, comprising: means for obtaining a first RF exposure level associated with when only a first antenna is used to transmit a signal; means for obtaining a second RF exposure level associated with when only a second antenna is used to transmit the signal; means for obtaining a third RF exposure level associated with when a plurality of antennas is used to transmit the signal in a coherent transmission mode, wherein the plurality of antennas includes the first antenna and the second antenna; means for determining a first transmit power limit associated with the coherent transmission mode based at least in part on the first RF exposure level, the second RF exposure level, and the third RF exposure level; and means for storing the first transmit power limit in one or more wireless communication devices.

Aspect 27: A computer-readable medium having instructions stored thereon for: obtaining a first transmit power limit associated with a coherent transmission mode, wherein the first transmit power limit is adjusted by a scaling factor associated with the coherent transmission mode; and transmitting first signals via a plurality of antennas in the coherent transmission mode at a first transmit power determined based at least in part on the first transmit power limit.

Aspect 28: A computer-readable medium having instructions stored thereon for: obtaining a first RF exposure level associated with when only a first antenna is used to transmit a signal; obtaining a second RF exposure level associated with when only a second antenna is used to transmit the signal; obtaining a third RF exposure level associated with when a plurality of antennas is used to transmit the signal in a coherent transmission mode, wherein the plurality of antennas includes the first antenna and the second antenna; determining a first transmit power limit associated with the coherent transmission mode based at least in part on the first RF exposure level, the second RF exposure level, and the third RF exposure level; and storing the first transmit power limit in one or more wireless communication devices.

Aspect 29: An apparatus comprising: one or more memories collectively storing executable instructions; and one or more processors coupled to the one or more memories, the one or more processors being collectively configured to execute the executable instructions and cause the apparatus to perform a method in accordance with any of Aspects 1-22.

Aspect 30: An apparatus, comprising means for performing a method in accordance with any of Aspects 1-22.

Aspect 31: A non-transitory computer-readable medium comprising computer-executable instructions that, when executed by one or more processors of a processing system, cause the processing system to perform a method in accordance with any of Aspects 1-22.

Aspect 32: A computer program product embodied on a computer-readable storage medium comprising code for performing a method in accordance with any of Aspects 1-22.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements, for example one or more dies and/or other components, packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
obtaining a first transmit power limit associated with a coherent transmission mode, wherein the first transmit power limit is adjusted by a scaling factor associated with the coherent transmission mode; and
transmitting first signals via a plurality of antennas in the coherent transmission mode at a first transmit power determined based at least in part on the first transmit power limit.

2. The method of claim 1, wherein:
the plurality of antennas is in an antenna group among a plurality of antenna groups; and
radio frequency (RF) exposure associated with the antenna group is treated as being mutually exclusive of RF exposure associated with each other antenna group among the plurality of antenna groups.

3. The method of claim 1, further comprising transmitting a second signal via at least one of the plurality of antennas in a non-coherent transmission mode at a second transmit power determined based at least in part on the first transmit power limit.

4. The method of claim 1, further comprising:
obtaining a second transmit power limit associated with a non-coherent transmission mode; and
transmitting a second signal via at least one of the plurality of antennas in the non-coherent transmission mode at a second transmit power determined based at least in part on the second transmit power limit, wherein the second transmit power limit differs from the first transmit power limit.

5. The method of claim 4, wherein the first transmit power limit is equal to a product of the second transmit power limit and the scaling factor.

6. The method of claim 5, wherein the scaling factor is a ratio of a sum of radio frequency (RF) exposure levels associated with single antenna transmissions to an RF exposure level associated with a multiple-input, multiple-output (MIMO) transmission.

7. The method of claim 4, wherein the non-coherent transmission mode comprises a single-input, single-output (SISO) transmission mode.

8. The method of claim 1, wherein the coherent transmission mode comprises a multiple-input, multiple-output (MIMO) transmission mode.

9. The method of claim 1, further comprising:
determining a time-averaged exposure based on one or more transmit powers and the first transmit power limit; and
determining the first transmit power based on the time-averaged exposure satisfying a radio frequency (RF) exposure limit.

10. The method of claim 9, wherein determining the time-averaged exposure comprises performing a linear computation of the time-averaged exposure based on the first transmit power limit.

11. The method of claim 9, wherein determining the time-averaged exposure comprises determining a sum of the one or more transmit powers normalized by the first transmit power limit.

12. The method of claim 1, wherein the first transmit power limit comprises a maximum time-averaged transmit power associated with a radio frequency (RF) exposure limit.

13. The method of claim 1, wherein obtaining the first transmit power limit comprises selecting the first transmit power limit among a plurality of transmit power limits in response to detecting the wireless device is transmitting coherent signals.

14. The method of claim 1, wherein obtaining the first transmit power limit comprises selecting the first transmit power limit among a plurality of transmit power limits in response to detecting the wireless device is transmitting in the coherent transmission mode.

15. An apparatus for wireless communication, comprising:
one or more memories collectively storing executable instructions; and
one or more processors coupled to the one or more memories, the one or more processors being collectively configured to execute the executable instructions to cause the apparatus to:
obtain a first transmit power limit associated with a coherent transmission mode, wherein the first transmit power limit is adjusted by a scaling factor associated with the coherent transmission mode, and
control transmission of first signals via a plurality of antennas in the coherent transmission mode at a first transmit power determined based at least in part on the first transmit power limit.

16. The apparatus of claim 15, wherein the one or more processors are collectively configured to execute the executable instructions to further cause the apparatus to control transmission of a second signal via at least one of the plurality of antennas in a non-coherent transmission mode at a second transmit power determined based at least in part on the first transmit power limit.

17. The apparatus of claim 15, wherein the one or more processors are collectively configured to execute the executable instructions to further cause the apparatus to:
obtain a second transmit power limit associated with a non-coherent transmission mode; and
control transmission of a second signal via at least one of the plurality of antennas in the non-coherent transmission mode at a second transmit power determined based at least in part on the second transmit power limit, wherein the second transmit power limit differs from the first transmit power limit.

18. The apparatus of claim 17, wherein the first transmit power limit is equal to a product of the second transmit power limit and the scaling factor.

19. The apparatus of claim 18, wherein the scaling factor is a ratio of a sum of radio frequency (RF) exposure levels associated with single antenna transmissions to an RF exposure level associated with a multiple-input, multiple-output (MIMO) transmission.

20. An apparatus for wireless communication, comprising:
means for obtaining a transmit power limit associated with a coherent transmission mode, wherein the transmit power limit is adjusted by a scaling factor associated with the coherent transmission mode; and
means for transmitting signals via a plurality of antennas in the coherent transmission mode at a transmit power determined based at least in part on the transmit power limit.
